(19) United States
(12) Patent Application Publication
(10) Pub. No.: US 2020/0205200 A1
(43) Pub. Date: Jun. 25, 2020

(54) Short Pre-RTS Packets for Wireless Collision Avoidance

(71) Applicants: David E. Newman, Poway, CA (US); R. Kemp Massengill, Palos Verdes, CA (US)

(72) Inventors: David E. Newman, Poway, CA (US); R. Kemp Massengill, Palos Verdes, CA (US)

(21) Appl. No.: 16/723,198

(22) Filed: Dec. 20, 2019

Related U.S. Application Data
(60) Provisional application No. 62/782,672, filed on Dec. 20, 2018.
(60) Provisional application No. 62/832,499, filed on Apr. 11, 2019.
(60) Provisional application No. 62/947,812, filed on Dec. 13, 2019.
(60) Provisional application No. 62/843,867, filed on May 6, 2019.
(60) Provisional application No. 62/861,055, filed on Jun. 13, 2019.
(60) Provisional application No. 62/924,914, filed on Oct. 23, 2019.

(51) Int. Cl. H04W 74/08; H04W 74/00

(52) U.S. Cl. CPC H04W 74/0816; H04W 84/12; H04W 74/006; H04W 74/004

(57) ABSTRACT

Improved protocols for wireless networking are disclosed. At low/zero marginal cost, embodiments can provide substantial reduction in collision frequency among nodes in a wireless LAN, including and especially at high traffic density. The reduction in collision rate may result in substantially reduced energy consumption, fewer re-transmission of messages, more efficient use of the available bandwidth, and higher user satisfaction overall. As the wireless traffic density soars in the coming years, embodiments can improve system utility while providing higher message success rates, reducing user frustration, minimizing message delays and message collisions, and eliminating node blocking. An array of embodiments can be implemented on existing and planned equipment with appropriate programming. And of vital importance in emergencies, the likelihood of a blocked 911 call can be significantly reduced.

### PRIORITY CLAIMS AND RELATED APPLICATIONS

This application claims the benefit of U.S. Provisional Patent Application No. 62/782,672, entitled “Infrared Pulse for Autonomous Vehicle Identification”, filed Dec. 20, 2018, and U.S. Provisional Patent Application No. 62/832,499, entitled “Autonomous Vehicle Localization System”, filed Apr. 11, 2019, and U.S. Provisional Patent Application Ser. No. 62/843,867, entitled “Identification and Localization of Mobile Robots”, filed May 6, 2019, and U.S. Provisional Patent Application No. 62/861,055, entitled “Rapid Wireless Communication for Vehicle Collision Mitigation”, filed Jun. 13, 2019, and U.S. Provisional Patent Application No. 62/924,914, entitled “Wireless Protocol for Improved Throughput and Fairness”, filed Oct. 23, 2019, and U.S. Provisional Patent Application No. 62/947,812, entitled “Short Pre-RTS Packets for Wireless Collision Avoidance”, filed Dec. 13, 2019, all of which are hereby incorporated by reference in their entireties. This application is also related to U.S. Pat. No. 9,896,096, issued Feb. 20, 2018, entitled “Systems and Methods for Hazard Mitigation” and U.S. patent application Ser. No. 16/148,390, filed Oct. 1, 2018, entitled “Blind Spot Potential-Hazard Avoidance System”, and U.S. patent application Ser. No. 16/503,020, filed Jul. 3, 2019, entitled “Rapid Wireless Communication for Vehicle Collision Mitigation”, U.S. patent application Ser. No. 16/422,498, filed Oct. 17, 2019, entitled “Identification and Localization of Mobile Robots”, and U.S. patent application Ser. No. 16/698,011, filed Nov. 13, 2019, entitled “Wireless Message Collision Avoidance with High Throughput”, the contents of which are incorporated herein by reference in their entireties.

### FIELD OF THE INVENTION

The invention relates to systems and methods for managing wireless communication to reduce wireless message collisions at high traffic density.

### BACKGROUND OF THE INVENTION

Many devices can communicate wirelessly. In the coming years, the number of wireless communication devices is expected to increase substantially. For example, sensors and actuators and other devices in the IoT (internet of things), vehicles including autonomous vehicles, cellular phones, wireless-enabled computers, and many other devices currently compete, and will continue to compete, for a limited number of communication channels. Emergent technologies such as 5G (fifth generation) wireless networking technology and subsequent generations (such as 6G and following technologies) are expected to enable many more applications, further driving congestion in the limited bandwidth available.

Message collisions and throughput delays become increasingly problematic as the wireless traffic density increases. When two wireless messages transmit on the same frequency channel at the same time, they interfere or “collide” with each other, rendering both messages unintelligible. Both of the colliding messages are usually re-transmitted after a variable delay time, which is intended to reduce the probability that the re-transmitted messages would again collide. This message collisions waste time and energy by requiring the collided messages, and any prerequisite messages, to be re-transmitted—which further contributes to congestion in the channel. Energy consumption may be an important parameter for battery-powered devices, since transmission often represents the highest power usage of the device. Message collisions and associated delays become exponentially worse at heavy wireless traffic densities, leading to customer frustration and anger, and most seriously of all, to life-threatening failure of vital services such as emergency 911 calls that are unable to access the communication channel when blocked by congestion. In vehicle applications, blocked access can lead to a life-threatening accident or delayed emergency response. Hence the demand for a vastly improved protocol that allocates access uniformly while handling high loads efficiently.

What is needed is means for reducing the number of wireless message collisions, particularly at high wireless traffic density.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

In a first aspect, a system for wireless communication comprises a transmitter configured to transmit wireless messages, a receiver configured to receive wireless messages, a processor operably connected to the transmitter and the receiver, and non-transient computer-readable media operably connected to the processor, containing instructions for causing the processor to perform a method. The method comprises transmitting a first wireless message, receiving a second wireless message, transmitting a third wireless message which is at least 10 times longer than the first wireless message, receiving a fourth wireless message, transmitting a fifth wireless message which is at least 4 times longer than the third wireless message; and receiving a sixth wireless message.

In a second aspect, a method for wireless communication between a node and a base station of a local area network comprises transmitting, by the node, an AQ message, transmitting, by the base station, a BQ message responsive to the AQ message, transmitting, by the node, an RTS message responsive to the BQ message, transmitting, by the base station, a CTS message responsive to the RTS message, transmitting, by the node, a DAT message responsive to the CTS message, and transmitting, by the base station, an ACK message responsive to the DAT message.

In a third aspect, a local area network comprises a plurality of nodes, each node comprising a processor, a transmitter, and a receiver; and a base station comprising a processor, a transmitter, and a receiver; wherein each node is configured to initiate wireless communication by transmitting an AQ message to the base station, the base station is configured to transmit a BQ message responsive to the AQ message, each node is configured to receive, after transmitting the AQ message, the BQ message, and to transmit an RTS message responsive to the BQ message, the base station is configured to transmit a CTS message responsive to the RTS message, each node is configured to receive, after transmitting the RTS message, the CTS message, and to transmit a DAT message responsive to the CTS message, the base station is configured to transmit an ACK message responsive to the DAT message.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

These and other embodiments are described in further detail with reference to the figures and accompanying detailed description as provided below.

### BRIEF DESCRIPTION OF THE DRAWINGS

FIG. 1 is a sketch showing a variety of devices communicating wirelessly, according to some embodiments.

FIG. 2 is a schematic showing an exemplary LAN comprising an array of nodes around a base station, according to some embodiments.

FIG. 3 is a schematic showing parts of an exemplary node, according to some embodiments.

FIG. 4 is a sequence chart showing a prior-art sequence of messages in wireless communication.

FIG. 5 is a flowchart showing how collisions can occur in prior-art messaging protocols.

FIG. 6 is a sequence chart showing intervals of an exemplary sequence for transmitting a wireless message, according to some embodiments.

FIG. 7 is a sequence chart showing intervals of an exemplary sequence for transmitting a wireless message while avoiding interference, according to some embodiments.

FIG. 8 is a flowchart showing an exemplary method for transmitting wireless messages, according to some embodiments.

FIG. 9 is a sequence chart showing various messages in an exemplary sequence to avoid interference, according to some embodiments.

FIG. 10 is a flowchart showing how an exemplary wireless transmission can detect and avoid interference, according to some embodiments.

FIG. 11 is a sequence chart showing intervals of an exemplary sequence for transmitting a wireless message including a two-byte AQ message, according to some embodiments.

FIG. 12 is a sequence chart showing intervals of an exemplary sequence for transmitting a wireless message including a two-byte AQ message and a two-byte BQ message, according to some embodiments.

FIG. 13 is a sequence chart showing intervals of an exemplary sequence for transmitting a wireless message including an AQ message containing a local identification code, according to some embodiments.

FIG. 14 is a sequence chart showing intervals of an exemplary sequence for transmitting a wireless message including a brief AQ message with unmodulated carrier signal transmission, according to some embodiments.

FIG. 15 is a flowchart showing an exemplary method to avoid interference using a brief transmission of unmodulated carrier signal, according to some embodiments.

FIG. 16 is a chart showing the results of a simulation in which exemplary Pre-RTS messages are added to an Incrementation protocol, according to some embodiments.

FIG. 17 is a chart showing the results of a simulation in which exemplary Pre-RTS messages are added to a Decrementation protocol, according to some embodiments.

FIG. 18 is a chart showing an exemplary formula for adjusting the waiting time and/or the contention window of a Decrementation protocol, according to some embodiments.

Like reference numerals refer to like elements throughout.

### DETAILED DESCRIPTION

Systems and methods are disclosed herein (the “systems” and “methods”) that can provide urgently needed protocols for wireless messages to avoid message collisions at high traffic density, according to some embodiments. Embodiments of the systems and methods may include one or two very brief preliminary or “handshaking” messages which may be transmitted before other standard messages such as RTS messages. Short messages that are transmitted before an RTS message may be termed “Pre-RTS” messages. For example, a very short message termed an “AQ” or “Ask-Quietly” message may be transmitted by a first transmitter, which initiates wireless communication by requesting permission to proceed with further transmissions (that is, to send an RTS message). A responsive “BQ” or “Begin-Quickly” message may be transmitted by another transmitter to grant permission for the original node to transmit an RTS message. Such preliminary short messages may reduce the incidence of message collisions, thereby allowing users to avoid unnecessary and repetitious re-transmission of messages, and thereby reducing congestion and reducing energy consumption, according to some embodiments.

Most of the examples below are based on CSMA-CA (carrier-sense multiple-access with collision avoidance) protocols which stem from the IEEE 802.11 protocols; however, embodiments of the disclosed systems and methods may be beneficially applicable to other wireless communication protocols as well. Enhancements such as QoS (quality of service) management, multiple-frequency systems, and other variations are not specifically discussed, however these and other enhancements may benefit from the disclosed systems and methods as well, as will be recognized by one of ordinary skill in the art given this disclosure. As used herein, a “wireless message” is information transmitted by radio-frequency waves. Examples of wireless messages are RTS (request-to-send), CTS (clear-to-send), DAT (data), and ACK (acknowledgement) messages. An RTS message is a short message sent by a transmitting node, typically to a base station, requesting permission to send a DAT data packet. A CTS message is a short message sent by the base station or receiving node in reply to an RTS. A DAT message is a longer message that a node sends upon receiving a CTS. An ACK message is a short message sent by the base station or receiving node, indicating that the DAT message was received in good order. In addition, as detailed below, one or more pre-RTS messages may be included, such as an AQ message transmitted by the node requesting permission to send an RTS message, and a BQ message sent by the base station or receiving node granting permission to send the RTS message. For example, a complete message sequence may include an AQ initiated by a node, a responsive BQ from the base station, followed by an RTS, CTS, DAT, and ACK from the node and base in alternation. An AQ message is a very short message that may be transmitted by a node prior to sending an RTS, and a BQ message is a very short message sent by the base station providing permission to the node to then send an RTS message, according to some embodiments. In this context, “very short” means much shorter than an RTS message, such as less than half or one-fifth or one-tenth or one-hundredth of the length of an RTS message. For comparison, DAT messages tend to be substantially longer than RTS, CTS, or ACK messages since the DAT message contains the information that the node wishes to transmit in addition to the addressing, identification, header, and other standard information. For this reason, the DAT message is typically at least twice as long as an RTS, and may be three or four or ten or more times as long as an RTS message. The base station may demark time in sequential time slots of a predetermined length. The base station may demark data units in terms of sequential bits of predetermined length, each bit comprising an irreducible unit of data. Alternatively, the base station may demark time or data according to sequential bytes comprising, typically, 8 bits (other embodiments may include bytes with different numbers of bits), or in sequential words comprising typically 2 or 4 bytes, or other sequential time or data units, “Predetermined length” refers to a duration in time such as in microseconds, or to data content such as a number of bits, as appropriate. In examples below, exemplary AQ messages are disclosed that span a single slot, whereas RTS messages generally span many slots such as 25 slots for example. In an alternative version, the AQ message may be as short as one or two or three or four bytes or less than four bytes or less than eight bytes within a single slot, while the slot may comprise, typically, many more bytes, such as 10 or 14 or 20 bytes for example. In a third version, the AQ message may comprise one or two bits within one byte of a single slot. The BQ messages may also be very short, such as one or two slots, or alternatively two or four or less than eight bytes, or alternatively a pattern of bits containing unmodulated or modulated carrier signals, according to some embodiments. While most of the examples herein show time demarked in slots, the messages may be organized using any suitable time or data unit scale, such as microseconds, bytes, bits, words, symbols, or other time or data demarcations.

A “packet” is a message. A “frame” is a message. A “node” is a communication device that includes a wireless transmitter, a receiver (or a transceiver), and a processor configured to analyze signals from the receiver and to cause the transmitter to transmit messages. For example, mobile phones, smart sensors, personal computers, and interconnected vehicles are among the many types of devices configured to communicate wirelessly. A local area network (LAN) is an array of nodes centered on a “base station” or “base”, also called an “access point”. The base station may communicate with all of the nodes in the LAN. The base station may include an interface between wired and wireless domains using a router or an Ethernet link, for example. The base station may manage the timing and other parameters of the LAN, for example by updating the parameters and communicating the updates to the nodes using periodic “beacon” messages. In some LAN configurations, the nodes communicate only with the base station, while in other configurations the nodes can communicate directly with each other. Base stations may also manage communication between adjacent LANs. Communication links from a base station to the wider network infrastructure are treated as “wired” herein, although they may include many types of information transfer technologies including conductive cables, optical fibers, microwave beams between fixed sites, satellite links, etc. Unless otherwise specified, the examples provided herein assume an isolated, managed LAN without direct node-node communication. “Traffic” is the amount of wireless communication detected by each of the nodes or by the base station (not to be confused with vehicle traffic). A “collision” is interference between two simultaneous wireless messages on the same channel, which generally results in both messages being garbled (not to be confused with physical collisions between vehicles). A “channel” is a frequency band used for wireless communication. “Wireless traffic density” is a measure of the amount of a communication channel that is occupied by wireless messages. In examples herein, the wireless traffic density may be represented by a parameter P, which equals 10 million times the probability that a particular node initiates a new message in a particular time slot. A message has been “successfully transmitted” and “successfully received” when the intended recipient receives it; the two terms are used interchangeably herein. “Transmission failure rate” is the number of AQ, BQ, RTS, CTS, and DAT message transmissions or attempted transmissions per unit time, that fail to receive a confirmatory reply. A “confirmatory reply” for an AQ is a BQ, for a BQ is an RTS, for an RTS is a CTS, fora CTS is a DAT, and fora DAT is an ACK. There is no confirmatory reply for an ACK. “Congestion” is a condition in which the wireless traffic density is so high that most of the nodes in a LAN spend most of their time waiting for a chance to send their messages. “Completion” refers to a complete RTS-CTS-DAT-ACK or AQ-BQ-RTS-CTS-DAT-ACK sequence successfully received. “Beacons” are messages broadcast by a base station to the nodes in its LAN, for purposes of management. A “carrier signal” is a wireless signal indicating that a message is in progress or is imminent. A node is “blocked” if it is forced to delay indefinitely while other nodes, with the same status or priority, are permitted to transmit multiple times. A “local identification code” is an identification code persistently representing a particular base station and distinct from the local identification codes of all other base stations within range of the wireless signals, wherein the local identification code is shorter than the MAC address of the base station (such as one or two bytes or less than four bytes). For example, the local identification code may be two bytes long.

The nodes and the base station all share a common medium or channel, such as a specific frequency range, and only one transmitter can successfully operate on that channel at a time. Therefore, a protocol is needed to sequence the various messages and avoid message collisions. Nodes that are ready to transmit a message may compete with each other for access. Typically, if a node is ready to transmit but detects that another node is already transmitting, the ready node is forced to wait until another already-transmitting node finishes, plus a “backoff” delay comprising a predetermined “waiting interval”, plus a randomly selected portion of a predetermined contention window. A “contention window” is a predetermined interval of time during which a node may transmit a message, unless the channel is already busy. “Rand” represents a randomly selected delay within the contention window. “Random” and “pseudorandom” are treated as equivalent herein. A node wishing to send a message may select, at random, a portion of the contention window, and may transmit after the waiting interval plus the randomly-selected portion Rand of the contention window, and may then transmit unless another node is already transmitting at that time, in which case the ready node must again perform another backoff delay. The “backoff” delay is then the waiting interval plus Rand. Some references call the waiting interval CWmin, meaning the starting time of the contention window. Likewise CWmax is the time of the end of the contention window, and CWwid is the width of the contention window. Thus, CWmax=CWmin+CWwid. The backoff time equals the waiting time plus Rand, which equals CWmin plus a random number times CWwid. In engineering terms, the contention window is a delayed gate, wherein the gate is the contention window, and the gate delay is the waiting interval. A node may transmit after the backoff delay if the channel is clear. Backoff delays are intended to spread out the transmissions to prevent multiple nodes from transmitting at the same time. Backoff delays also reduce the traffic density to avoid congestion. However, if the backoff delay is too long, throughput may be reduced. To avoid having multiple transmissions starting at the same time, each node wishing to transmit may first sense whether the medium is busy by detecting any wireless messages or carrier signals that may be present. If no carrier signal is present, the node determines that the channel is clear, and the node may transmit. If the node detects the carrier signal of another message already in progress, the node must wait until the competing message has ended, then wait for the waiting interval, and then wait an additional randomly selected portion of the contention window, and may then begin transmission (unless another node has already started transmitting at that time). On the other hand, if the node wishing to transmit is already in a backoff delay, then the node may simply stop timing its backoff delay while the other transmission is in progress, and then resume timing the backoff delay as soon as the channel is clear. In this way, the nodes compete for an opportunity to transmit while avoiding some types of collisions.

A “slot” is a unit of time, such as 10 microseconds or 20 microseconds typically. Delay intervals are commonly subdivided into slots. The durations of the various messages may be measured in slots. Each slot can accommodate a number of bytes of data, such as 14 bytes for example, wherein a byte may comprise 8 bits. The nodes and the base station may be configured to detect and interpret bits of message data in a bitwise sequential manner, and likewise to transmit data in a bitwise sequential manner. “Throughput” is the number of successful completions per unit time in the LAN. A “successful completion” or a “completion” is a complete RTS-CTS-DAT-ACK or AQ-BQ-RTS-CTS-DAT-ACK message sequence. In practice, a successful completion may be indicated simply by receiving an ACK message, since this includes all the other messages by implication. A “transmission failure” or “failed transmission attempt” is a wireless message that was not received by the intended recipient in good order. Such failure may be due to a wireless collision or other interference or noise for example. From the point of view of a node, a failed transmission attempt is an AQ which is not followed by a BQ, or an RTS which is not followed by a CTS, or a DAT which is not followed by an ACK, within a predetermined “listening” time interval. A failed transmission may also comprise a commit-to-send while a carrier signal is detected, or a commit-to-send while a Reserved interval is in effect. In each case of a failed transmission, a backoff delay is “required”. A backoff delay is also required whenever a node sends an AQ and fails to receive a BQ, or sends an RTS and fails to receive a CTS, or sends a DAT and fails to receive an ACK, or whenever the node commits to transmit a message while a detectable carrier signal or a Reserve state is present. A backoff delay is not required when a node commits to send a message while no carrier signal is detectable and no Reserve state is in effect. A Reserve state is initiated by each node upon receiving a CTS message from the base station, specifying a duration in which transmissions are prohibited, or in some embodiments by a BQ message wherein the duration of the Reserved state is determined by the sum of the lengths of the RTS and CTS messages. After the Reserved state expires, each node (other than the node to which the CTS or BQ is intended) refrains from transmitting for the specified duration, thereby avoiding collisions. A node that sends a DAT and fails to get an ACK must generally start all over by sending an RTS, receive a CTS, and then may re-transmit the DAT.

In some embodiments, the waiting interval and/or the contention window may be adjustable. Such adjustments may be made according to the wireless traffic density or other conditions, since shorter delays are generally appropriate for low traffic densities and longer delays for high traffic densities. The delay parameters may be arranged for example to optimize the throughput or the message success rate or to minimize overall delays or other LAN performance metric. A lower limit and an upper limit may be set for each parameter, such as an upper and lower limit for the waiting interval, the contention window, and the entire backoff time, among other parameters. The waiting interval and/or the contention window may be increased or decreased each time the backoff delay is required. For example, the waiting time may initially be set to a predetermined “initial waiting interval”, and then increased or decreased successively after each successive failed transmission attempt. Likewise, the width of the contention window may be set at an “initial contention window” value, and then may be increased or decreased after each successive failed transmission attempt. Then, after a successful completion (as indicated by the node receiving an ACK responsive to the node's DAT message), the waiting interval and/or contention window may then be restored to their initial values. Thus when another backoff delay is required after a successful completion, the waiting interval and/or the contention window are restored to their initial values for the subsequent backoff delay. In other embodiments, the node may restore the delay parameters back to their initial values more frequently, such as doing so after receiving a CTS in response to an RTS, as well as an ACK in response to a DAT. Restoring the delay parameters to their initial values under both CTS and ACK receptions would thereby separate the delays associated with sending an RTS from the delays associated with sending a DAT. Most of the examples herein assume that the delay parameters are reset to their initial values only upon completion of the full message sequence including ACK. “Incrementation” refers to increasing the waiting interval and/or the contention window after each failed attempt to transmit a message. Thus, with Incrementation, on each subsequent transmission attempt, the node is forced to wait longer, on average, than that for the initial attempt. Prior-art systems typically employ Incrementation. For example, in typical prior-art systems, the initial waiting interval and/or contention window may be made quite short, such as 1 or 2 slots, and then the waiting interval and/or contention window is/are doubled upon each successive failed transmission attempt. Such protocols are said to employ “binary exponential” delays. In contrast, some embodiments of the systems and methods disclosed herein may employ Decrementation. “Decrementation” refers to decreasing the waiting interval and/or the contention window after each failed transmission attempt, so that on each subsequent transmission attempt, the node is allowed to transmit sooner, on average, than for the initial attempt. Embodiments of decrementation protocols may provide an initial waiting interval and an initial contention window duration which are set according to current wireless traffic conditions, for example to optimize throughput or minimize delays. Then, after each failed transmission attempt, the waiting interval and/or the contention window may be decremented, for example by subtracting a predetermined decrement from each delay parameter. Decrementation thereby provides a competitive advantage to the delayed node relative to other nodes which have not yet been delayed. Improved fairness and equality follow, according to some embodiments. As used herein, “fairness” means providing a competitive advantage to nodes that have waited longest, relative to other nodes that have not waited so long. “Equality” means providing equal transmission opportunities to all the nodes in a LAN. The “blocked-node problem” is a form of congestion at high traffic density in which one or more nodes in a LAN is forced to remain in a backoff state indefinitely while other nodes are permitted to transmit repeatedly.

Decrementation of the waiting interval and/or contention window, upon each failed transmission attempt, may be performed by the processor of the transmitting node in various ways. For example, the processor can subtract a predetermined decrementation value from the current waiting interval and/or contention window. Alternatively, separate decrementation values may be applied to the waiting interval and the contention window individually, for further optimization of performance. As a further alternative, the waiting interval and/or the contention window parameters may be decremented by multiplying the values by a factor less than 1 upon each failed transmission attempt, thereby providing a sliding scale of decrementation values, with the largest decrementations being provided to nodes with the longest current delay parameters. Decrementation may be applied differently to the waiting interval and contention window values, for example by decrementing the waiting interval upon one failed attempt and then decrementing the contention window on the next failed attempt, and continuing in alternation, for example. The decrementation value(s) may be set according to a timing parameter of the wireless protocol, such as a slot width or a round-trip communication time or a full RTS-CTS cycle time for example. The decrementation value(s) may be varied according to the magnitude of the interval being decremented, such as making the decrementation value larger when the waiting interval and/or contention window is close to its maximum limit, and smaller when the interval is close to its minimum limit. As a further alternative, the node may calculate each decremented waiting interval and/or each decremented contention window using the number of backoff delays performed by that node, which may be stored in memory for example. The number of backoff delays may be incremented before or after each backoff delay, and may be set to zero after each successful completion or each ACK message reception by the node. Then, whenever a backoff delay is required, the node may calculate a fully decremented waiting interval by multiplying the number of backoff delays by a predetermined waiting interval decrementation value, and subtract that product from the initial waiting interval. Likewise, the node may calculate a fully decremented contention window by multiplying the number of backoff delays by a predetermined contention window decrementation value, and subtract that product from the initial contention window. It is immaterial whether the delay parameters are decremented incrementally upon each backoff delay, or are calculated anew using the current number of backoff delays, since the resulting effect is the same for both methods. In each case, the waiting interval and/or the contention window may be constrained to be between a predetermined lower limit and a predetermined upper limit, respectively.

To adjust the initial waiting interval and/or the contention window, a node may sense the state of the channel at various times and determine how often a carrier signal is present, thereby determining a traffic density value as seen by that node. The node's processor can then adjust the initial waiting interval value and/or the initial contention window value, for example in order to optimize a performance metric, such as throughput. In an embodiment, the processor may adjust the initial waiting interval longer in high-density traffic to prevent congestion, and lower in low-density traffic for faster access, and likewise for the initial contention window. Alternatively, the initial values may be set by the base station, wherein the base station may monitor the wireless traffic density, calculate updated values for the initial waiting interval and/or the initial contention window and/or other parameters, and may broadcast beacon messages to the nodes dictating the initial waiting interval and/or the initial contention window and/or other parameter values. The initial waiting interval and/or the initial contention window may be adjusted together or separately, for example using different decrementation values. The initial waiting interval and/or the initial contention window may be set according to formulas, such as formulas that take as input the traffic density and produce as output a recommended value for the initial waiting interval and/or the initial contention window. The parameters may be further adjusted depending, for example, on whether the interfering messages are long or short in duration, whether the competing messages come from a few highly active nodes or from a large number of nodes acting separately, and other things that affect media access.

The various delay parameters listed, and other networking parameters, may be adjusted using artificial intelligence and/or machine learning. For example, LAN performance (based on message throughput, average delay times, collision rates, etc.) may be monitored as the various parameters are adjusted. Then, after accumulating a preferably large number of measurements of LAN performance at different parameter settings, an adjustment algorithm may be derived. Machine learning may be employed by allowing the algorithm to adjust parameter settings in one or more LANs and then determining whether the updated settings resulted in improved or degraded LAN performance. In addition, artificial intelligence may be employed in developing the algorithm(s) that relate adjustable parameter(s) to measurement value(s), and by successively testing and refining trial algorithms the artificial intelligence may gradually improve the algorithms. For example, if the collision rate and throughput are related in a complex way to the traffic density and the average message duration, the artificial intelligence with machine learning may be able to derive algorithms for setting the initial waiting time, the initial contention window, and/or other delay parameters and/or other adjustable parameters of the LAN to optimize those performance metrics.

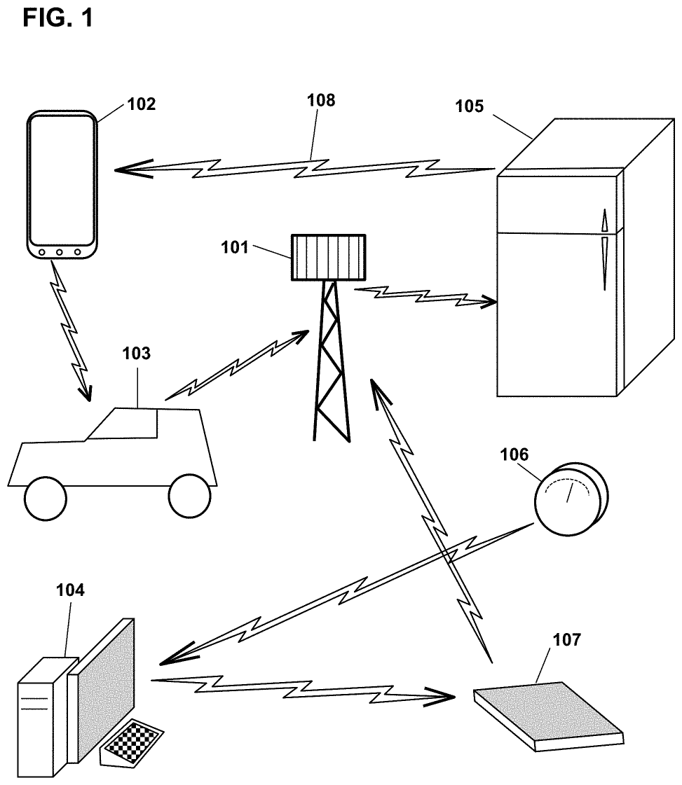

Turning now to the figures, FIG. 1 is a schematic showing a base station 101 and numerous wireless nodes 102-107 including a cellular phone 102, a vehicle 103, a computer 104, a smart refrigerator 105, an autonomous sensor such as a thermostat 106, and a tablet computer 107. Embodiments of the systems and methods disclosed herein may be designed to manage the wireless messages 108, for example to reduce collisions.

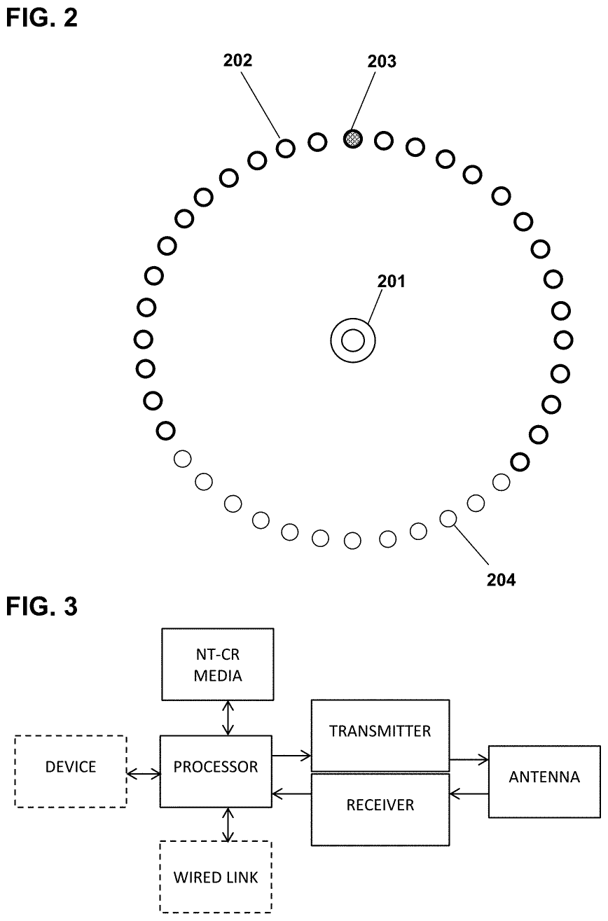

FIG. 2 is a schematic showing an exemplary LAN comprising a base station 201 and a number (in this case 40) of nodes 202 arrayed around the base station 201. The nodes 202 communicate only with the base station 201, not with each other in this example. Due to the various inter-node distances, each node can detect signals from only some of the other nodes, and the remaining nodes are “hidden”. In the figure, a particular node 203 (shaded) can detect signals from the other nodes 202 shown heavy, but not from the more distant nodes 204 shown light. In this case, each node 202 can detect signals from twenty-seven of the other nodes, and the diametrically opposite twelve nodes are hidden. However, all of the nodes 202 can communicate with the base station 201, and the base station 201 can communicate with all of the nodes 202; thus none of the nodes 202 is hidden to the base station 201.

FIG. 3 is a schematic showing components of an exemplary node, according to some embodiments. A processor (such as a computer, microcontroller, FPGA, ASIC, etc.) may send data to a transmitter which may send electromagnetic signals to an antenna, which may emit electromagnetic waves comprising a wireless message. The same antenna may receive electromagnetic energy comprising wireless messages from other nodes or from the base station, and may convey the energy to the receiver, which may convert the energy into a form that the processor can recognize. In addition, the processor may be operatively connected to non-transient computer-readable media (“NT-CR media”) containing data and/or instructions for methods. Nodes are usually connected to a device (shown in dash) such as a vehicle or sensor or mobile phone, for example. A base station, on the other hand, usually includes a wired connection to a larger network such as the Internet, using a router or other instrumentation for example.

In some embodiments, the transmitter and receiver may be combined into a transceiver. In some embodiments, two separate antennas may be provided, one for the transmitter and a second antenna for the receiver, thereby allowing separate optimization of the high-power transmission and the low-power received signal.

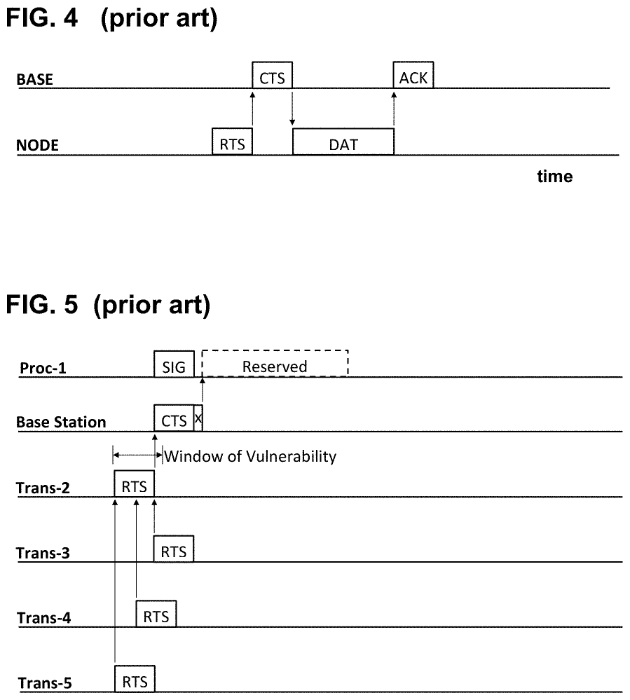

FIG. 4 is a sequence chart showing various prior-art messages as a function of time. A “sequence chart” is a chart showing events versus time along a horizontal axis, similar to the display of a logic analyzer. Arrows indicate sequential timing. Minor delays due to the speed of light and the like are ignored here and in all the examples. Interframe spaces and the like are ignored.

In the protocol shown, a node wishes to send a data packet DAT to a receiving entity, which in this case is the base station. But first, the node obtains permission to transmit, by sending an RTS message. Typically the RTS includes the MAC address or other identifier of the transmitting node, the MAC address or identifier of the intended recipient, an indication that this is an RTS message, various preamble and header and terminal portions, and optionally a duration value indicating how long the node desires to occupy the channel for the subsequent DAT and ACK messages. The receiving node, typically the base station, may then send a responsive CTS message granting access, and also optionally designating a Reserved state for the duration that appeared in the RTS message. Other nodes in the LAN are obligated to refrain from transmitting for that duration, to avoid collisions with the expected DAT and ACK messages. After receiving the CTS, the transmitting node may then send the data package DAT, after which the base station may send an ACK acknowledgement if the DAT was received in good order.

FIG. 5 is a sequence chart showing how collisions can occur in prior-art systems, despite the use of a Reserved interval for collision avoidance. As mentioned, the RTS can include a duration datum which the base station can repeat in a CTS message. Other nodes in the LAN, or within range of the node or base station, may then remain silent for the duration of the Reserved interval to avoid causing a collision. In the figure, the actions of a processor Proc-1 of a first node are shown in the first line, actions of the base station are indicated next, followed by the transmitters Trans-2, Trans-3, Trans-4, and Trans-5 of other nodes in the LAN. Trans-2 sends an RTS, for which the base station sends a CTS reply. Proc-1, as well as all the other nodes, detects the CTS carrier signal and therefore they all inhibit transmission during the interval labeled SIG. Some of the nodes may also detect the RTS activity, but in this example the Proc-1 node is too far from the Trans-2 node to detect its RTS carrier signal. All the nodes can detect the base station messages, and therefore SIG occupies the time of the CTS. The CTS message may include a duration datum, which all the nodes can interpret and can withhold their transmitters for the full Reserved interval according to the duration datum. Also, Trans-2 would normally respond to the CTS by transmitting a DAT package, but in this example a collision occurred which garbled the CTS. Therefore Trans-2 did not receive a recognizable CTS and hence did nothing (or initiated a backoff and re-transmission, not shown).

The base station began listening for a DAT message immediately after sending the CTS. Detecting no carrier signal from Trans-2, the base station determined that the DAT was not forthcoming. Therefore, there is no need to impose a Reserved interval of silence. The base station therefore transmitted a very brief beacon message “x” cancelling the Reserved interval, which is shown in dash since it was canceled. Nodes may then transmit at will after the cancellation.

The collision may have occurred in one of at least three ways. Trans-3, the transmitter of a third node, may have been too far from Trans-2 to hear the RTS (that is, the second node was hidden from the third node), and so Trans-3 may have coincidentally transmitted its own RTS message simultaneously with the CTS. Since nodes cannot receive and transmit at the same time, the third node was unable to detect the simultaneous CTS and therefore caused a collision.

Another way the collision could have occurred is shown by Trans-4, which also is a “hidden node” from Trans-2. Trans-4 began transmitting its RTS in the middle of the Trans-2 message, which was hidden from it, and therefore caused a collision.

Another collision scenario is shown for Trans-5, which is not a hidden node from Trans-2. However, Trans-2 coincidentally began sending its RTS at the same time (that is, in the same slot) as the Trans-2 RTS, which therefore collided. In each of these scenarios, the collision garbled the original RTS and/or the CTS, and hence the Reserved interval was either not started or was canceled upon failure to detect a responsive DAT. The other nodes are then free to transmit during that time. However, the two collided nodes (Trans-2 and either Trans-3 or Trans-4 or Trans-5) were not free to transmit right away since, after a failed transmission attempt, they must wait for a full backoff interval before again attempting an RTS.

Each of the depicted RTS messages comprised a failed transmission attempt. A “Window of Vulnerability” is shown as a double arrow spanning the RTS message plus the first slot of the CTS. Collisions can occur during the Window of Vulnerability because there is no Reserved state during those times. After the first slot of the CTS, the other nodes can detect the base station signals and refrain from transmitting, but any node that coincidentally begins transmitting during the first slot of the CTS will collide with the base station

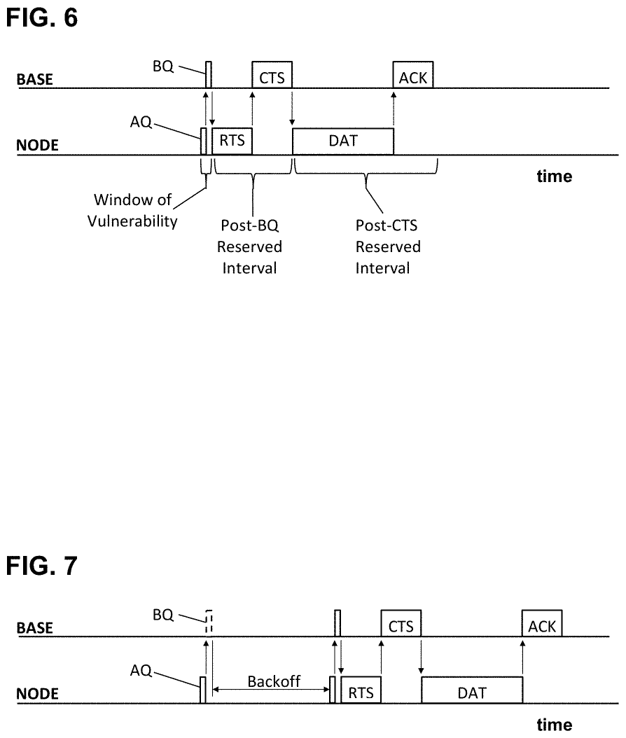

FIG. 6 is a sequence chart showing how collisions can be reduced using exemplary Pre-RTS AQ and BQ messages, according to some embodiments. Here the node first sends a very short AQ message, with a duration of just one slot or two slots for example. The base station responds with a short BQ message, if the communication channel is available. (If the channel is not available, the base station does nothing, and the node then fails to receive a BQ and therefore enters a backoff delay.) The BQ message is also shown as one or two slots, but in other embodiments the BQ message may have any duration. After receiving the BQ message, the node then transmits a conventional RTS message, followed as described above by a CTS, DAT, and ACK messages according to standard protocols. Also shown is a Window of Vulnerability spanning the AQ and the first slot of the BQ message in which a collision may occur due to accidental simultaneous transmissions from hidden nodes.

A Post-BQ Reserved Interval is shown spanning the RTS and CTS messages. Each node that had not sent an AQ message is configured to withhold all transmissions after detecting the BQ message. Any node that detects a base station's BQ message is obligated to respect the Post-BQ Reserved Interval and not transmit during that time (except, of course, for the node that sent the AQ message). In other words, each node may be configured to detect a BQ message which is NOT associated with any AQ message transmitted by that node, and upon detecting such a BQ message, the detecting node may determine that the BQ message is associated with a different node, whereupon the detecting node is obligated to respect a Reserved interval and refrain from transmitting for sufficient time for RTS and CTS messages which normally follow a BQ. Thus the Post-BQ Reserved Interval may be long enough to span the anticipated RTS and CTS messages, thereby protecting those two messages from collisions. In addition, the CTS message may include a duration datum indicating the duration of the planned DAT and ACK messages (the Post-CTS Reserved Interval), so that each node that detects the CTS message, and had not sent the RTS message, would prevent its transmissions for the duration of the expected messages. (The BQ message does not need a duration datum because the length of the RTS and CTS messages is predetermined and is already known to the nodes.) In this way the Post-BQ Reserved Interval prevents collisions during the RTS and CTS messages, and the Post-CTS Reserved Interval prevents collisions during the DAT and ACK messages. Hence the remaining unprotected Window of Vulnerability consists of just the AQ message and the first slot of the BQ message.

As is apparent from the figure, the Pre-RTS messages AQ and BQ serve to reduce the Window of Vulnerability substantially relative to the case of FIG. 5 (that is, with no AQ or BQ messages), since to the length of the AQ message comprising one or two slots is much shorter than an RTS message, which typically has a length of 10 or 20 or 25 or more slots. With the Pre-RTS messages, collisions could occur if two nodes happen to transmit their AQ messages in the same time slot, or if two nodes that are hidden from each other send AQ messages in subsequent slots and collide with a BQ message. In both cases, the nodes would fail to receive a BQ response and would begin backoff delays. The third collision scenario (a node begins transmitting while a hidden RTS is in progress) is nearly eliminated due to the short duration of the AQ message. The only collision types left are the ones associated with a simultaneous initiation of two messages in the same slot, which is far less likely than an RTS-overlap type of collision. Therefore the AQ-BQ Pre-RTS messages, with the AQ message being substantially shorter than the RTS, can reduce the number of collisions.

FIG. 7 is a sequence chart showing how an exemplary node can initiate a backoff delay in response to a collision involving a short AQ or BQ message. The node transmits a short AQ message and waits a predetermined interval to receive the expected BQ response message from the base station. However, unbeknownst to the transmitting node, a second node sent another AQ message (not shown) in exactly the same slot, or alternatively a hidden node sent another AQ message simultaneously with the BQ response. In either case, the original node failed to receive an intelligible BQ response and therefore initiated a backoff delay, as required. The BQ message is shown in dash to indicate that it is either not present or is garbled by interference.

After the backoff delay has expired, the original node again transmits its AQ message, and this time the competing node has given up or is still in its own backoff delay, and therefore the AQ is received by the base station in good order. The base station responsively sends a BQ granting permission to proceed, whereupon the node transmits its RTS, the base follows with a CTS, the node finally gets to send its DAT message, and the base acknowledges it with an ACK.

As a further option, the LAN may include some nodes that support an AQ-BQ Pre-RTS handshaking as shown, and other nodes that do not support it, all within the same LAN. In that case, the base station may be configured to transparently and automatically handle communications with both types of nodes simultaneously or sequentially. The Pre-RTS supportive nodes can begin with an AQ message when they wish to transmit, while the non-supportive nodes can begin with an RTS whenever they are ready to transmit (assuming the channel appears clear at that time), and the base station may respond with a BQ to the AQ message, or a CTS to the RTS, as in the prior art. All the nodes are configured to inhibit transmission following a CTS message to avoid colliding with the DAT message, and all the supportive nodes are configured to also inhibit transmission following a BQ message to avoid colliding with the RTS and CTS messages. In this way, the base station may transparently accommodate both AQ-BQ-supporting nodes and AQ-BQ-nonsupporting nodes in the same LAN. In summary, if one node uses the AQ-BQ Pre-RTS handshaking for collision avoidance, the base station responds to a valid AQ from that node with a BQ as described. If, however, another node, which does not support the AQ-BQ signals, starts with an RTS (that is, without transmitting the AQ message first), then the base station responds with a CTS. Thus the base station can respond automatically to both AQ-BQ supporting and non-supporting types of nodes within the same LAN, as well as other protocols.

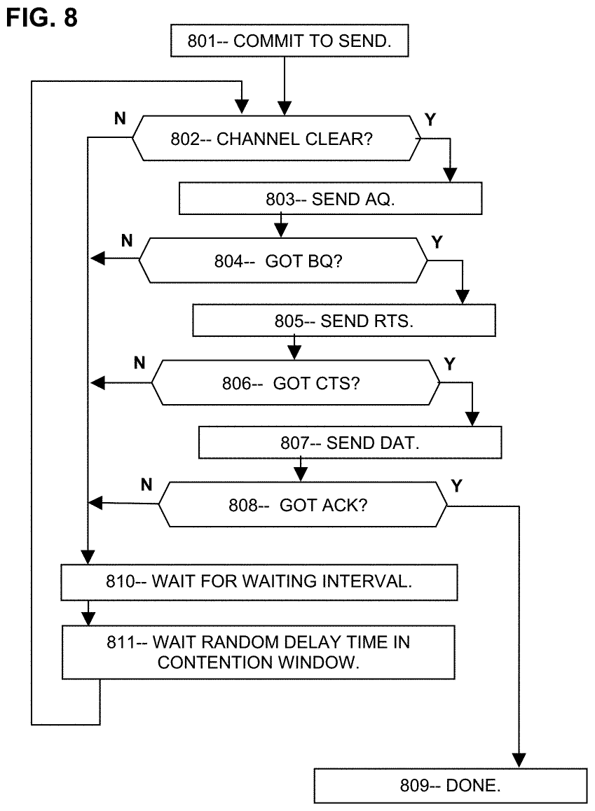

FIG. 8 is a flowchart showing an exemplary method for managing messages including the Pre-RTS handshaking, according to some embodiments. At 801, a node commits to send messages, and then checks whether another message is detectable at 802. If the channel seems clear (that is, the node detects no carrier signals or messages from other non-hidden nodes), then the node can send an AQ message at 803. The AQ message may be made as short as possible while still signaling to the base station that one of the nodes wishes to initiate communication. Thus, the AQ may be a single slot of transmitted energy, including a code that indicates that the message is an AQ message. It is not necessary at this point for the base station to know which of the nodes in the LAN is transmitting. It is sufficient that the base station determines that one of the nodes wishes to send an RTS to that base station, which is the only information that the AQ generally conveys.

At 804 the base station sends a responsive BQ message, which may be as short as the AQ, or alternatively the BQ may be longer and include further information such as the address of the base station.

If two nodes happen to begin transmitting AQ messages simultaneously, then their messages will collide and both will be garbled. The two nodes need not be hidden from each other; they simply start at the same time and therefore cannot know that the other node is also transmitting. Nodes cannot receive and transmit simultaneously, and therefore they have no way of knowing that their simultaneous AQ messages collided. However, the base station can determine that the transmissions collided due to the interference between the two signals on the same frequency. In that case, the base station would not send a BQ response. The two nodes, after listening for a BQ response and getting none, would then realize that their AQ messages had been collided. Accordingly, both nodes would then begin a random backoff delay before trying again.

Returning to the flowchart, in this case the AQ was not collided and the base station sent the BQ without interference. The various nodes in the LAN may detect the BQ message and, knowing that they had not recently sent an AQ message, would thereby determine that the BQ was intended for another node. That is, the nodes could determine from the BQ that another node had sent an AQ and gotten the BQ response, which would initiate a Post-BQ Reserved Interval. All the other nodes (other than the one that sent the AQ) would then inhibit transmitting for the Post-BQ Reserved Interval which may span the expected durations of the RTS and CTS messages, plus any interframe spaces and the like as needed to prevent collisions until the CTS is done.

Then at 805, the node that originally sent the AQ and then received the BQ can responsively transmit an RTS message. The RTS can contain the address of the transmitting node, the identification of the base station, various headers and the like, plus optionally a duration datum, and other information in the RTS. Upon receiving the RTS message, the base station learns which node is offering to communicate. The base station can then send a CTS message, and can direct the CTS specifically to the node that sent the RTS by including the node address in the CTS. By this means, the other nodes in the LAN can determine that the CTS is not for them. In addition, if the RTS includes a duration value for the DAT plus ACK durations, the base station may repeat the duration value in the CTS, and thereby reserve the channel for that amount of time, the Post-CTS Reserved Interval. The other nodes can detect the CTS, read the duration datum, and then refrain from transmitting for that duration. The Post-BQ Reserved Interval and the Post-CTS Reserved Interval thus avoid many collisions that could otherwise occur.

After the node receives the CTS at 806, it then sends a DAT message at 807 containing the data that the node wishes to communicate. The DAT message is different from the other messages listed, because the DAT generally includes data that the node wishes to convey, whereas the other messages generally contain information about node intent and identity, and other things, but not the data that the node (or its user or its running application) wishes to communicate.

Upon receiving the DAT, the base station can responsively send an ACK message to that node. If the node receives the ACK at 808, the communication is complete at 809.

If the node fails to receive a BQ or CTS or ACK response at 804, 806, and 808 respectively, or if the node detects another node's carrier signal at 802, then the node can initiate a backoff delay at 810. The backoff delay can be a sum of a predetermined waiting interval at 810 plus a random portion of a predetermined contention window at 811. The randomized delay helps the nodes to avoid transmitting at the same time. After the backoff delay, the flow returns to 802 and the node again checks for carrier signals.

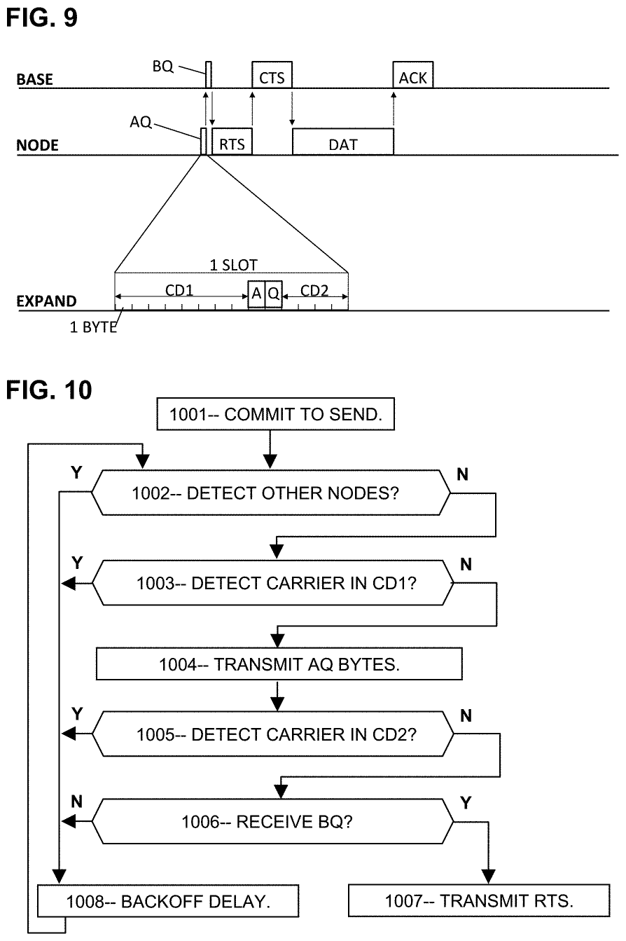

FIG. 9 is a sequence chart showing an alternative exemplary method for transmitting Pre-RTS messages for collision avoidance, according to some embodiments. Again, the activities of the base station (BASE) and a NODE are shown versus time, along with an expanded view (EXPAND) of a portion of the NODE activity. In the depicted protocol, sequential AQ and BQ messages are transmitted prior to the RTS-CTS sequence. In the depicted protocol, the AQ message consists of a subset or portion of a single slot, rather than filling the entire slot as in the previous example. In FIG. 9, the slot is divided into a number of bytes (14 bytes in this case). Each byte comprises 8 bits generally, and can convey an ASCII character or other symbol or other data encoded in those 8 bits. In the figure, the AQ message consists of two bytes which are shown encoding the ASCII characters A and Q, thereby identifying the message as an AQ message. The remaining portions of the slot, marked as CD1 and CD2, may include unmodulated carrier or alternatively may include no transmission by the node. In the latter case (no transmission during the bytes other than the AQ bytes) the node may monitor the channel to detect another node's carrier signals. Detection of another node's carrier signals during the CD1 or CD2 time would indicate that another node is trying to send an AQ message in the same slot as the original node, which would comprise a competing message but not a collision since the two transmissions would not be simultaneous but would occupy different portions of the same slot. If the second node's transmission happened to occur in the same bytes as the first node's AQ message, then the two messages would collide; however the probability of the selected bytes being simultaneous in the two node transmission is reduced by the ratio of the width of the AQ message to the width of the slot, or 2/14= 1/7 in the example shown. To summarize, the original node's transmitter is active during the two A and Q bytes as shown, and its receiver is active during the CD1 and CD2 times. The probability of a collision of AQ messages is reduced according to the ratio of the length of the AQ message to the length of one slot.

The particular byte or set of bytes occupied by the AQ transmission may be selected randomly within a slot. In the depicted example, the 14 bytes in the depicted slot may accommodate the two-byte AQ message in any one of seven non-overlapping positions, and inhibiting the transmitter from transmitting during bytes other than the bytes occupied by the AQ message. By selecting the timing of the AQ transmission randomly within the slot, the node may avoid collisions with other nodes that may be transmitting AQ messages in the same slot, but occupying a different set of bytes. For example, if a first node transmits a two-byte AQ message in bytes 1 and 2, while a second node transmits another two-byte message in bytes 3 and 4, those messages would not interfere with each other because the wireless signals would not overlap in time. Rather, the two messages would be received as sequential bytes within the slot, but without interference, at the base station. The base station may be configured to recognize such a double-AQ composite message as indicating that two nodes are requesting permission to transmit at substantially the same time, and therefore would not send a responsive BQ message. Both of the transmitting nodes would then fail to receive a BQ message, and would then initiate separate backoff delays before again attempting to communicate.

If, on the other hand, the two nodes happen to select the same two bytes for their AQ messages, then those two transmissions will overlap and collide, in which case the base station would receive only a garbled message due to interference, and therefore would not transmit a BQ. The two nodes, failing to receive a BQ response, both initiate backoff delays. Thus, in each case of two competing nodes transmitting AQ messages in the same slot, the base station would discover the potential conflict and the nodes would initiate backoff delays, regardless of which subset of bytes are selected for each of the transmissions.

In addition, the first node may be configured to receive transmission from other nodes during the bytes not occupied by the AQ message, and the first node may abort its AQ message if it detects a competing message or carrier signal during the CD1 period, thereby avoiding interfering with the earlier-transmitting node. For example, another node may transmit a two-byte AQ message during CD1, in which case the depicted node can abort its intended AQ and imitate a backoff. This is an advantage because it allows the earlier of the two competing nodes to continue, whereas if they both transmit their AQ messages, they both would be forced to delay. Thus, the nodes cooperate to enhance the overall throughput by detecting carrier activity during the CD1 time and withholding their transmissions, since it would be futile to transmit after detecting a competing signal in the same slot.

In another example, a third node may happen to begin an RTS or other message at the same slot as the first node plans to send the AQ bytes. Since RTS and the other messages generally occupy the entire slot, the first node could detect that signal during CD1 and again may abort its intended AQ to avoid colliding. In each case, the first node recognizes during CD1 that a competing node has already claimed the slot, and may then begin a backoff delay to avoid colliding.

During CD2, after transmitting the AQ message, the first node may again detect any competing activity. For example, a fourth node may send another AQ message in the same slot but using a set of bytes during CD2, in which case the first node could detect it and could begin a backoff delay without waiting for the BQ message, since the node would already know that there will be no BQ message after such a dual-AQ transmission. Alternatively, if the base station unexpectedly fails to detect the conflict and sends a BQ message, the first node may voluntarily enter a backoff and allow the other node to proceed with communication, since the alternative would be a near-certain collision.

As a further example, the AQ message may comprise any number of bytes, such as 1 or 2 or 3 or 4 or more bytes of transmission. In addition, the bytes of the AQ message may be contiguous as shown, or they may be separated with periods of no transmission or periods of unmodulated carrier between the separated bytes. In addition, the base station may be configured to interpret the distribution of bytes and any intervening bytes as indicating an AQ message.

FIG. 10 is a flowchart showing an exemplary method for implementing the actions of FIG. 9, according to some embodiments. At 1001 a node commits to send, but before doing so, it listens during a complete slot at 1002 to detect any ongoing traffic. If no messages or carrier signals are detected during that first slot, the node at 1003 again listens for new signals during the CD1 portion of a second slot. If no traffic is detected in CD1, the node may transmit its AQ message at 1004, and then at 1005 may again listen for competing carrier signal during the remaining portion CD2 of the second slot. If no competing traffic was detected in CD2, the node may then listen at 1006 for a BQ message in a subsequent slot, or alternatively during a predetermined listening interval. Then, after receiving a BQ message, the node may proceed with the usual RTS-CTS sequence at 1007. If the node detects a carrier signal during the first slot, or during CD1 or CD2, or fails to receive a BQ message, then the node may initiate a backoff delay at 1008 before again attempting to communicate.

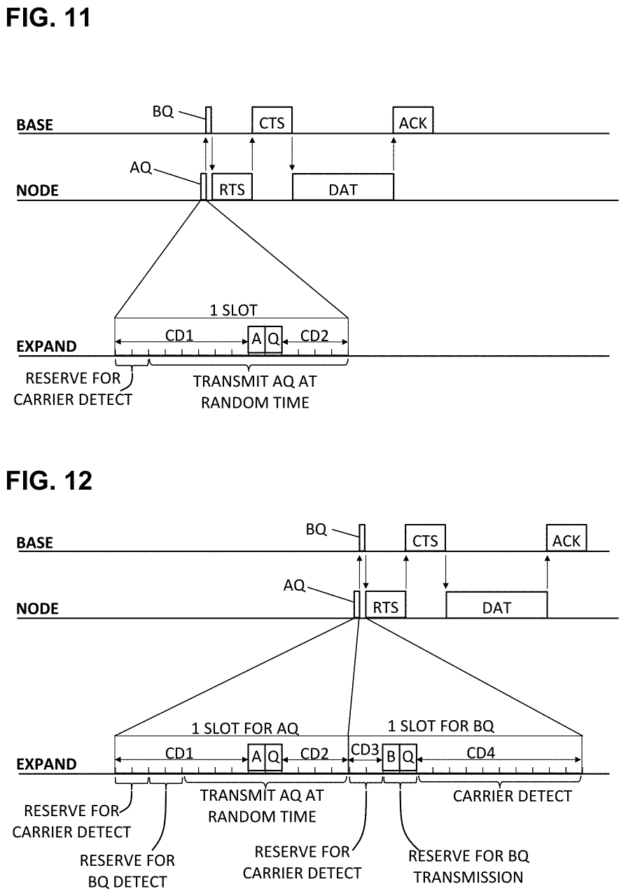

FIG. 11 is a sequence chart showing an exemplary method for avoiding collisions by reserving a portion of a slot, such as the first one or two bytes, to detect competing carrier signals. The figure includes an expanded view of the AQ slot in EXPAND. In the method of FIG. 10, a first slot was scanned for carrier signals before the node proceeded to the slot containing the AQ message, which thus takes an extra slot for carrier detection. (Interframe spaces, processor working times, speed-of-light effects and the like are ignored herein; the BQ slot may occur in the next-following slot after the AQ slot, or in another slot thereafter, in some embodiments.) In contrast, the method of FIG. 11 avoids waiting the initial blank slot. Instead, the node is configured to use the first byte or two of the AQ slot for carrier detection, and therefore not for transmission of the AQ bytes. In that case, it is no longer necessary to spend a complete slot before the AQ slot (as in step 1002 of FIG. 10) for carrier detection. Competing activity such as RTS or spurious activity may be detected during the first two bytes of the AQ slot, which are labeled “Reserve for carrier detect” to indicate that the bytes are to be used for carrier detection exclusively. The AQ bytes may then be transmitted at a random position among the remaining bytes of the slot. In the example shown, bytes 1 and 2 are reserved for detecting carrier signals, and the two-byte AQ signal is transmitted at a random place among the remaining 12 bytes. Preferably, the node scans for competing signals in all of the bytes labeled CD1 before the AQ transmission, so as to detect other AQ signals that select different transmission times within the slot as well as competing RTS messages and other messages, and may begin a backoff delay upon detection any such activity. This saves time by avoiding a collision without dedicating a full slot to carrier detection before the AQ slot.

FIG. 12 is a sequence chart showing another exemplary method for arranging the AQ and BQ messages to avoid collisions, according to some embodiments. An expanded view shows both the AQ and BQ slots spread out with individual bytes demarked. Here the AQ message occupies two bytes of a first slot, and the BQ message occupies two bytes of a second slot. (Other embodiments may involve different numbers of bytes for the AQ and BQ messages.) As with the example of FIG. 11, the first two bytes of the AQ slot are reserved for carrier detection, and then the next two bytes are reserved for BQ detection. Correspondingly, the base station may be configured to transmit the BQ message always during that second pair of bytes (or at another pre-arranged position within the slot). As depicted, the BQ message occupies bytes 3 and 4 of the BQ slot, and in the other bytes of the BQ slot the base station transmitter is silent so that the receiver can monitor the channel for conflicts.

In the example shown, a node that wishes to send an AQ message may first monitor the bytes 1 and 2 of the AQ slot for carrier detection, and also the next two bytes in the AQ slot for detecting an unexpected BQ message from the base station. Detecting a BQ message before the node has sent its AQ message would indicate that another node, such as a hidden node. had previously sent an AQ and the present node was unable to detect it. In that case the depicted node would be obligated to refrain from sending its AQ message and would begin a backoff delay. If, however, no carrier signals are detected during the CD1 interval, including the carrier-detect bytes 1 and 2 plus the BQ-detect bytes 3 and 4, plus any other bytes remaining before the AQ bytes, then the channel is apparently clear and the node can send its AQ message in the next two bytes as shown. In the depicted example, the AQ message may be sent at a random time during the remaining 10 bytes after the reserved bytes, if no activity was detected during the CD1 interval. In addition, the node can watch for any unexpected activity during the final bytes CD2 after the AQ transmission, since any signal detected during CD2 would indicate that a competing node was transmitting in the same slot. In that case, both nodes would begin backoff delays.

The BQ message in this example is depicted as two bytes, placed in bytes 3 and 4 of the BQ slot which is the slot following the AQ slot. The first two bytes of the second slot (CD3) are reserved for carrier detection, as before, followed by the two BQ bytes, and the remaining 10 bytes (CD4) may be used for additional carrier detection to detect any unexpected transmissions following the BQ.

By making both the AQ and BQ messages shorter than a slot width, and using the rest of the time to watch for interfering signals, the node and the base station can avoid collisions.

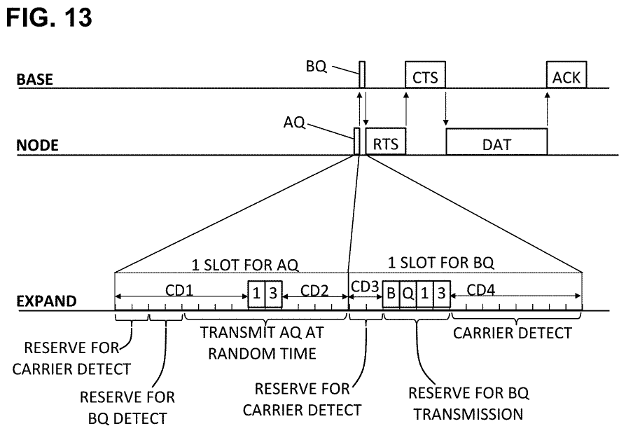

FIG. 13 is a sequence chart of an exemplary protocol for collision avoidance in which the base station is identified in the AQ and BQ messages, according to some embodiments. An advantage of identifying the base station in the AQ and BQ signals may be that confusion may be reduced in situations where multiple LANs overlap. If two base stations belonging to two different LANs can hear a node's generic AQ message (such as the symbols “A” and “Q”), the two base stations have no way of knowing which base station the AQ is intended for, and if both base stations emit a BQ message, they will collide. This may be avoided by identifying, in the messages, which base station the transmitting node belongs to. The base station and node activities are shown versus time, and the AQ and BQ slots are shown expanded with individual bytes demarked. In the example, each base station has a two-byte code, the “local identification code”, which identifies the base station relative to other base stations of other LANs that may be within range. Normally, each base station has a MAC address comprising six bytes which identifies that station worldwide. However, it is not necessary to send the complete MAC address with each message; it is sufficient to specify the targeted base station among those base stations within reach of the node's transmitter. Wireless networking generally involves low-power transmission with a relatively short range, which may reach a small number of neighboring LANs. In the example, the base station has a 1-byte or 2-byte or 3-byte local identification code. For example, a 2-byte code provides 64,000 unique combinations, and thus is sufficient for distinguishing each base station from the neighboring base stations within the short distance that wireless messages typically can reach. The base station may transmit beacon messages informing the nodes of the base station's local identification code. The base station may communicate its choice of local identification code to other neighboring base stations so that the other base stations can select their own local identification codes differently. Alternatively, a more central entity, such as a network manager or other authority, may assign local identification codes to each base station according to their geographical locations or other considerations, and may communicate those assigned codes to the various base stations using, for example, the Internet.

In the depicted example, the first two bytes of each AQ or BQ slot are reserved for detecting carrier signals of potentially interfering nodes, and the next two bytes of the AQ slot are also reserved, for detecting BQ messages as described above. If no conflicting transmissions are detected, the AQ message is then transmitted in two bytes at a random location among the remaining 10 bytes of the first slot as shown. However, the AQ message in this example consists of the two-byte local identification code of the base station of the node's LAN, shown as “13” in this case, rather than the arbitrary A and Q symbols of the previous example. Thus, the local identification code for the base station of the node's LAN is 13. By including the local identification code of the intended base station in the AQ message, the node can specify which particular base station is associated with the transmitting node. That base station can then recognize its code, which in the example is presented within an otherwise blank slot. Thus, a valid AQ message is a slot with no carrier in 12 of the bytes and the local identification code of a base station in the other two bytes. Since the local identification of any particular base station differs from the local identification codes of all the other base stations within range of the wireless messages, any other base stations within range can determine from the embedded local identification code that the AQ is not for them, and can ignore the AQ request.

The second slot in the example shows the BQ response, according to some embodiments. The first two bytes of the BQ slot, labeled CD3, are again reserved for carrier detection to avoid colliding with a message (such as an RTS) that starts coincidentally in the same slot. The next four bytes in this example are “BQ” (which identifies the message as a BQ response and not an AQ request), followed by the local identification code of the base station that is transmitting the BQ message, or 13 in this example. Thus, the base station confirms that its BQ message is associated with the immediately-preceding AQ message, since they both cite the same local identification code. The remaining bytes (8 in this example) in CD4 may be used for additional carrier detection and collision avoidance. Including the base station's local identification code in the BQ message is a way to prevent confusion in applications where neighboring LANs are within range of each other. A node can receive the BQ message including the base station's local identification code, and can thereby determine whether that base station is in the transmitting node's LAN or in a neighboring LAN. If the local identification code does not match the node's base station, then the node can ignore the message. If the neighboring node has recently sent an AQ message to its base station, and then detects the BQ message from a different LAN (as indicated by the local identification code), then the neighboring node can determine that the BQ is intended for a different node which is presumably hidden, and can therefore enter a backoff delay. In this way, collisions can be avoided both within each LAN and also between the nodes of two neighboring LANs.

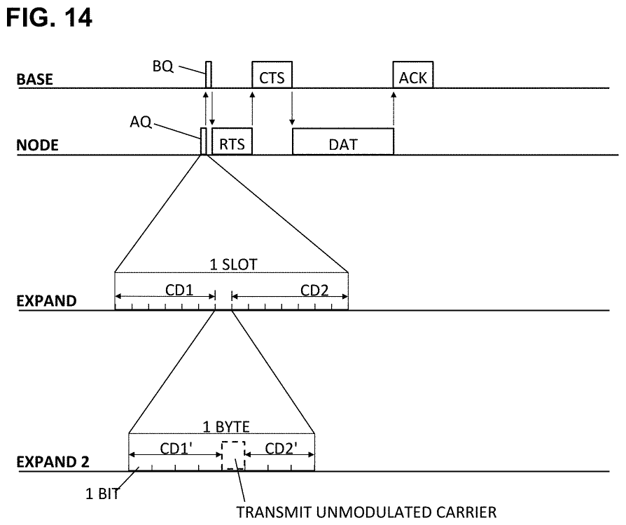

FIG. 14 is a sequence chart showing an exemplary protocol for transmitting an AQ message with little or no collision potential, according to some embodiments. The chart shows the activities of a base station, a node in the same LAN as the base station, an expanded view of one slot of the node's transmission, and in an even more expanded view (Expand 2) showing a single byte within that slot, with its individual bits demarked. Within that byte, a transmission of modulated or unmodulated carrier signal is transmitted by a node, indicating that the node wishes to send an RTS message. The transmission occurred during a time corresponding to a single bit, which generally corresponds to 50-100 nanoseconds of wireless transmission. Alternatively, the short transmission may occupy a small number of bit positions, such as 2 or 3 or 4 or less than eight bit positions within the byte, in which some bits of the AQ transmission may be modulated and other bits unmodulated. In the remainder of the byte and the remainder of the slot, the node transmitter is silent, that is, the node is transmitting no carrier signals during the time (or bit positions) of the AQ slot other than the single bit (or the few bits) comprising the AQ message itself. The receiver may be configured to detect carrier signals from competing nodes during the bytes and bits of the slot other than the bit or bits used for the AQ message transmission.

The receivers of the nodes and base stations are generally configured to receive signals and detect signals as short as a single bit position, and to interpret the signal as a modulated or unmodulated carrier signal. Normally, wireless transmissions are modulated using phase modulation, for example, or phase modulation in combination with other types of modulation. To achieve the necessary information transfer rate, the base station receiver is able to discern the carrier signal as well as the modulation type and degree in each successive bit of data, thereby to decode the information in the signal. The base station may be configured to detect the single-bit carrier signal, and to interpret that signal as an indication that a node wishes to communicate, or more specifically, the base station may be configured to interpret the short one-or-few-bit transmission as an AQ message. The base station may respond by transmitting a BQ message, thereby permitting the node to proceed by sending an RTS message. That RTS message then contains further information such as the node address, the whole address of the base station, the expected DAT+ACK duration, etc. On the other hand, if the base station detects more than one period of unmodulated carrier (indicating that more than one node is trying to talk at once), or an unrecognizable signal anywhere in the slot, then the base station may be configured to refrain from sending a BQ signal, so that the transmitting node or nodes would then begin backoff delays due to failing to receive a BQ confirmation.

The node can listen for signals from other nodes during the CD1 time before the byte in which the short transmission occurs, and also during the several bits of the interval CD1′ which occurs in the AQ byte before the one-bit transmission. If any activity is detected, the node may abort the AQ transmission. Electronics are readily available that can abort the transmission nearly instantaneously after detecting such a carrier signal, and thereby abort the AQ transmission if a competing signal is detected at any time during CD1 or CD1′. After transmitting the one-bit unmodulated carrier signal, the node can then listen for further potential interference during CD2′ and CD2 intervals. Detection of any activity during any of those listening times would indicate potential interference. If the base station detected such interference, the base station could withhold the BQ signal, thereby causing both competing nodes to enter backoff delays. If the node detects such interference after transmitting, such as during CD2′ or CD2, the node can begin a backoff delay at that time, without waiting for a BQ reply.

An advantage of a super-short one-bit unmodulated carrier transmission is that it is very unlikely to be collided with another node's AQ signal, even if they both decide to send such AQ messages in the same slot. Each node may select a bit at random within the slot; hence the probability of the transmissions colliding is very low. In the depicted example, each slot includes 14×8=112 distinct bits and therefore 112 different temporal positions for the transmission. The likelihood of the two transmissions colliding would then equal the probability that the two nodes pick the same slot divided by 112.

An advantage of using an unmodulated carrier signal for the AQ bit may be that unmodulated carrier waves are minimally intrusive. Many protocols include means for recovering isolated bit errors, using for example parity bits, bitwise-encoding algorithms, recovery algorithms and the like. With such recovery means, a processor in the base station can detect an isolated damaged bit and deterministically calculate the correct bit, thereby saving an ongoing message and avoiding a costly re-transmission.

Another advantage of using a very short AQ transmission, such as a single bit, is that it saves energy. Many wireless devices, especially in the IoT, are battery-powered, and therefore must conserve energy whenever possible. The most energy-intensive operation that each node performs is often wireless transmission, so minimizing the transmission duration saves power.

As a further alternative, the AQ message may comprise any number of bits, such as 2 or 3 or 4 or 8 bits or more, as needed to transmit an unambiguous request to send an RTS message. The several bits may be contiguous, or they may be distributed across a slot with carrier-free spaces between the short transmissions. Such an on-off code may be readily understood as an AQ request. As a further alternative, the bit or bits of the AQ transmission may be modulated, such as modulated in a characteristic way to indicate that the transmission is an AQ message.

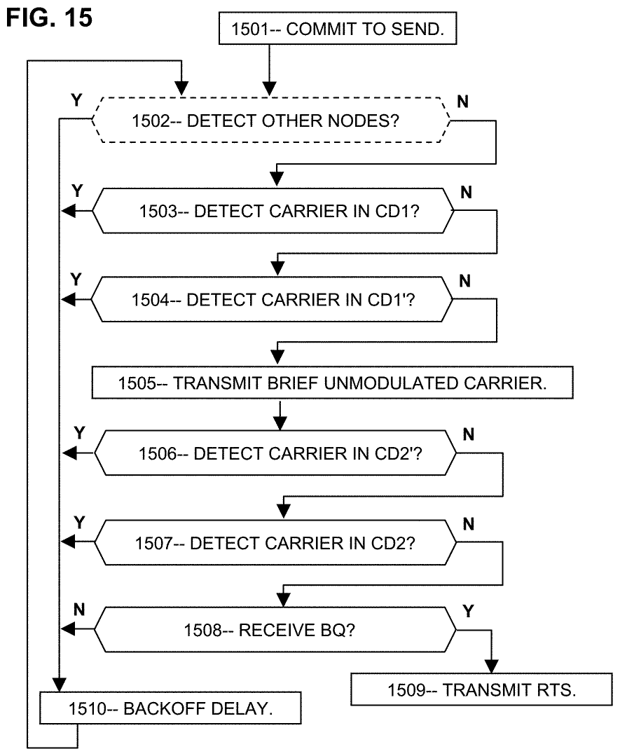

FIG. 15 is a flowchart showing an exemplary method for using a short unmodulated carrier signal as the AQ message, according to some embodiments. At 1501 a node decides to communicate, but before doing so, optionally (in dash) the node may spend a slot listening for carrier signals or messages from other nodes at 1502. If no such signals are detected, the node can continue to monitor the channel during the CD1 and CD1′ intervals at 1503 and 1504, and then if no competing signals are detected, the node can transmit a brief unmodulated carrier signal at 1505. The node can continue to monitor the channel during the CD2′ and CD2 intervals at 1506 and 1507, and then if nothing else goes wrong, the node can receive a BQ message from the base station at 1508. After receiving the BQ message, the node may then transmit an RTS message at 1509 and proceed with the remainder of the communication chain. However, if the node detects a competing signal in any one of those listening times, or if the node fails to receive a BQ message within a predetermined interval, then the node begins a backoff delay at 1510, and then returns to 1502 to again attempt a communication.

Alternatively, the transmission in 1505 may be modulated, for example modulated in a way that indicates that the transmission is an AQ message, or other information such as an indication of which base station is being targeted by the AQ message for example.

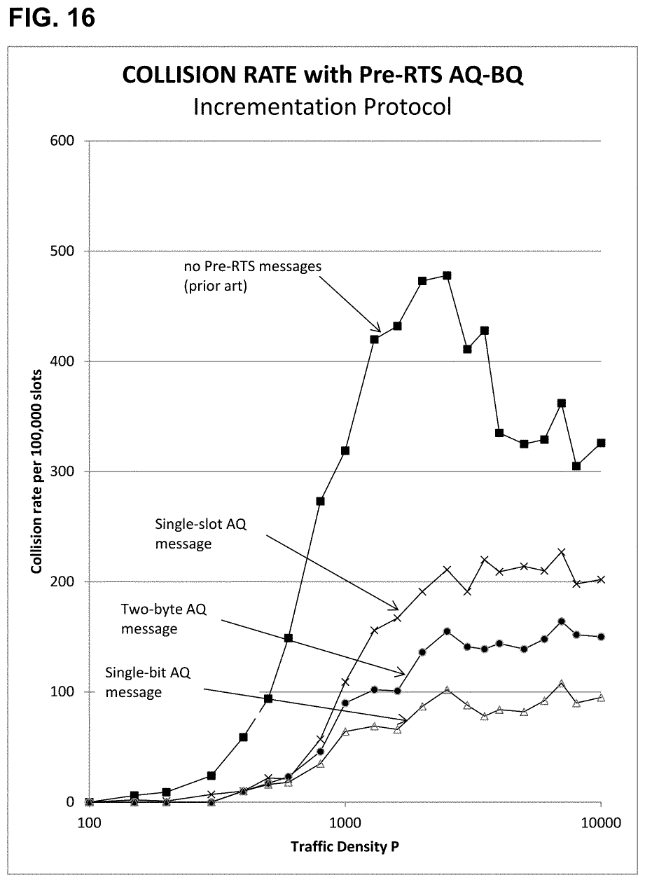

FIG. 16 is a chart showing the results of a computer model or simulation of a LAN with nodes communicating with a base station. In the simulation, 40 nodes are distributed around a base station, similar to that depicted in FIG. 2. Each respective node is hidden to 12 other nodes and is visible (receivable) to the other nodes. All of the nodes can communicate with the base station.

The model was run numerous times with different assumptions. In a first series of runs, the nodes followed a protocol in which the backoff delay time was initially short (2 slots), and was subsequently doubled after each failed transmission attempt. Such a delay protocol is sometimes called a binary exponential delay protocol. Protocols in which the delay parameters are increased after each transmission attempt are termed “Incrementation” protocols herein. In a second series of runs, an opposite delay protocol was followed, in which the backoff delay was initially set at a predetermined delay value appropriate to the current traffic density, and then was made shorter, or Decremented, after each failed transmission attempt. An advantage of the Decrementation protocol may be that nodes that have been delayed the most times are then granted a competitive advantage relative to other nodes that have not been delayed as much. The Decrementation protocols therefore improve fairness. Decrementation can also eliminate the “blocked node” problem in which some nodes are held off indefinitely while other nodes are permitted to transmit multiple times, which commonly occurs at high traffic density with Incrementation protocols.

The chart shows the number of collisions among the 40 nodes in a run consisting of 100,000 slots, as a function of the traffic density P. Here P is equal to the probability that a particular node will initiate a new message in a particular time slot, times ten million. The range of P covers low to high traffic density. Generally, low traffic density corresponds to P<800, high traffic density for P>4000, and medium traffic density is between those limits. Collisions are rare at low traffic density in all cases modeled. In the medium traffic density range, the nodes actively compete for access to the communication channel. At high densities, nearly all the nodes are in backoff delay most of the time.

The simulation in the chart of FIG. 16 used the Incrementation protocol to manage backoff delays (binary exponential delays in this case). Four plots are shown. The uppermost plot, with dark square markers, shows the collision rate versus traffic density with a conventional protocol with no Pre-RTS short messages such as AQ and BQ messages. Instead, in the upper curve, each node started directly with an RTS message, as in the prior art. As expected, the collision rate is low for low traffic densities, and then increases rapidly at medium traffic density as the nodes transmit at will. The collision rate subsides somewhat at higher densities because each node then spends most of its time in backoff delay, and the backoff timers are configured to detect other node transmissions and only count down while the channel is clear, thereby avoiding collisions when the backoff delay expires.

The next curve, demarked with “X” indicators, shows the collision rate with one-slot AQ and BQ messages added (that is, the AQ and BQ messages were each one slot wide). Nodes were configured to detect the BQ messages, and to respect a Post-BQ Reserved Interval after the BQ message to avoid colliding with the following RTS and CTS messages. Nodes were also configured to detect the CTS message and to respect a Post-CTS Reserved Interval after each CTS message. With those Reserved requirements, collisions were strongly inhibited during the RTS and subsequent messages, but can still occur during the short AQ or BQ messages. The chart shows a substantial reduction in collision rate when the AQ and BQ messages are added, due primarily to the fact that a single-slot AQ is much shorter than a standard (25 slot, typically) RTS message, and likewise the single-slot BQ is much shorter than the CTS, thereby reducing the number of coincidental overlaps with messages from the hidden nodes.

The next-lower plot, with filled circular markers, is the collision rate using AQ and BQ messages that are only two bytes long, each randomly positioned within sequential slots. The AQ and BQ two-byte messages were positioned at random within the 14-byte slot. The reduction in collision rate was due to the reduction in duration of the AQ and BQ messages. Nodes also monitored the channel during bytes of the AQ and BQ slots to detect competing transmissions, and entered a backoff delay if such were detected.

Finally, in the lowest plot with triangular markers, the collision rate is shown for an AQ message consisting of a single bit of unmodulated carrier, placed at random within the slot. The collision rate is reduced due to the extreme shortness of the 1-bit transmission. Some protocols can fully recover a 1-bit noise error, as mentioned; however that feature was not used in this run, and chance overlaps with the one-bit AQ were counted as collisions.

The chart thus shows that at medium and high traffic density, the Pre-RTS handshake messages AQ and BQ can substantially reduce the collision rate in an Incrementation type communication protocol.

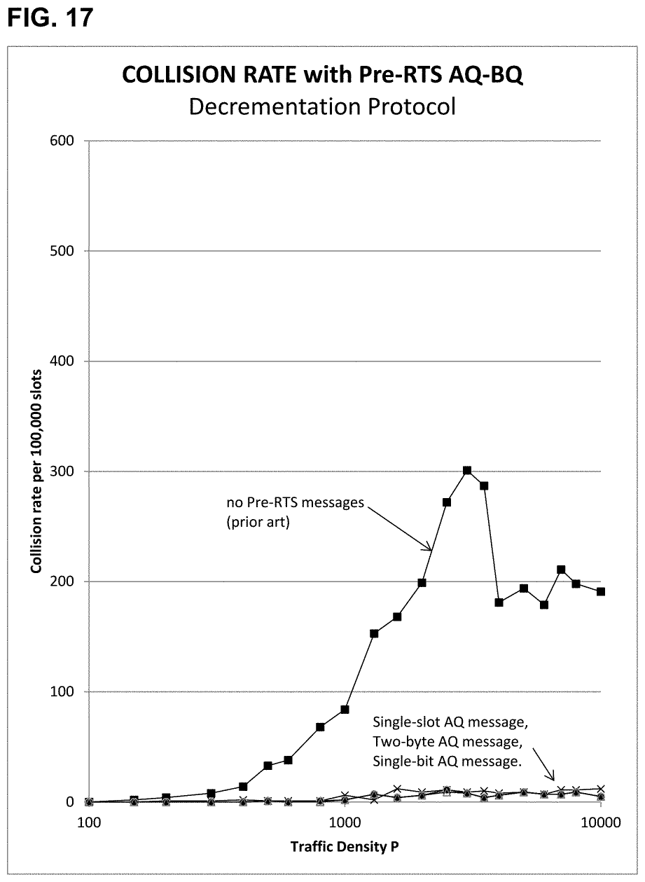

FIG. 17 is a chart showing the collision rate versus traffic density, using the same simulation and assumptions as for FIG. 16, except that a Decrementation protocol was used for backoff delays instead of Incrementation. As mentioned, the Decrementation protocol manages the backoff delay by adjusting the initial waiting time and/or the initial contention window width according to the current traffic density. After each failed attempt at communication, due to a collision or to the detection of another message already in progress, the node initiates a backoff delay but with the waiting interval and/or the contention window shortened by a predetermined decrementation amount, thereby obtaining a competitive advantage relative to other nodes that have not yet been delayed. The Decrementation protocol results in far fewer AQ or RTS transmission requests than the Incrementation protocol, because the Decrementation protocol starts with an initial waiting interval and/or initial contention window sized appropriately for the traffic density, whereas the Incrementation protocol starts with a very short waiting interval and/or contention window and then successively lengthens them until successfully communicating. Thus, the Incrementation protocol generally produces many more communication requests per successful message than the Decrementation protocol.

The chart shows an upper plot with dark square markers, showing the collision rate for a prior art case without the Pre-RTS AQ and BQ messages. The collision rate increases in medium traffic density and then levels off at high densities. This is similar to the corresponding non-AQ plot of FIG. 16 with the Incrementation protocol, however the overall number of collisions is lower with the Decrementation protocol because it generates fewer transmission requests and hence fewer collisions. In this case, the Decrementation protocol generated about 30% fewer collisions than the Incrementation protocol, with no AQ-BQ messages, due to the fewer transmission attempts.

At the bottom of the chart is an overlapping set of three curves which cannot be easily distinguished. Those lower curves correspond to the collision rate observed using each of the three AQ model versions. One of the overlapping plots is for the single-slot AQ and BQ messages, one plot is for the two-byte AQ and BQ messages, and one plot is for a single-bit AQ message, as described above. The three plots with various AQ-BQ versions are clustered at the bottom because each of the protocols with AQ and BQ messages in a Decrementation delay protocol exhibited very few collisions. The remaining collisions require an accidental coincidence of messages from hidden nodes occurring at the same time. Similar, extremely low collision rates are thus seen for all three of the tested protocols with Decrementation and Pre-RTS messages.

In summary, the results shown in FIGS. 16 and 17 thus indicate that the collision rate can be reduced in either the Incrementation or Decrementation protocol by introducing AQ and BQ Pre-RTS messages which are much shorter than the RTS messages. The reduced collision rate is due to the reduced likelihood of overlap with a competing message. In addition, even more dramatic decreases in the collision rate are seen with the Decrementation protocol and any of the AQ-BQ versions. Indeed, the model indicates that the collision rate can be reduced almost to zero.

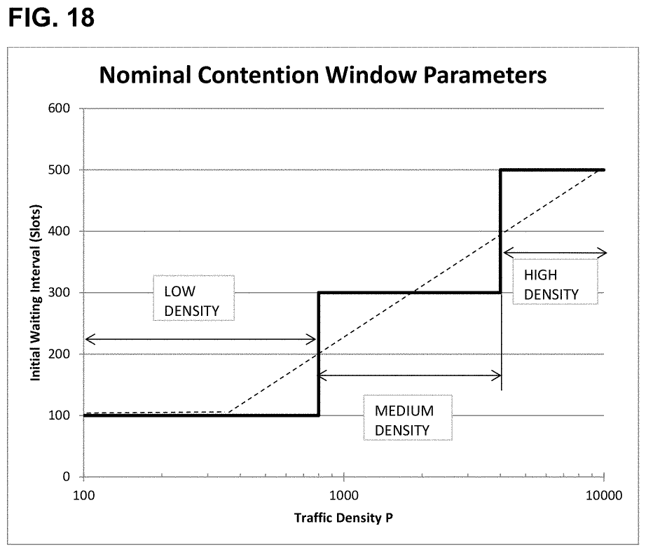

FIG. 18 is a chart showing two exemplary functions for setting the initial waiting interval and/or the initial contention window in an exemplary Decrementation protocol, according to some embodiments. The chart shows how the initial waiting interval and/or the initial contention window may be set based on the traffic density, among other possible inputs. The heavy line demarks a function that determines three settings that correspond to low, medium, and high traffic density respectively. For example, at low traffic density (such as P<800 for example), the initial waiting interval and/or the initial contention window may be set to 100 (slots). At a medium traffic density (such as 800<P<4000), the initial waiting interval and/or the initial contention window may be set to a higher value such as 300. The higher value may be advantageous for regulating the rate of new message starts during active node-node competition, which may be characteristic of medium traffic density. At high traffic density (such as P>4000), the initial waiting interval and/or the initial contention window may be set to a higher value, such as 500, recognizing that most of the nodes spend most of their time in backoff delay waiting for their turn to transmit. Practitioners may adjust the values of the initial waiting interval and/or the initial contention window according to the design features or the performance results of their particular LAN. Practitioners may also adjust the boundaries between low, medium, and high traffic densities based on the parameters of their particular LAN, such as the number of nodes in the LAN, the average length of messages in the LAN, and other parameters. Practitioners may change the number of traffic density regions, such as using only two (such as low and high) traffic density regions for setting the values, or adding a fourth region, or adding as many regions as are appropriate for their particular LAN.

As an alternative method, the chart also shows dashed lines that provide a continuously variable value for the initial waiting interval and/or the initial contention window versus traffic density. The dashed line may be based on a formula. In one embodiment, shown in the chart, the initial waiting interval and/or the initial contention window may be set to a constant value such as 100 for traffic densities below a first value, such as 400, as indicated by the horizontal dashed line. The initial waiting interval and/or the initial contention window may be increased at higher traffic densities according to an equation which, in the example shown, is a linear relationship between the delay parameters and log(P), where log(P) is the logarithm (base 10) of the traffic density P.

Considering the two dashed lines of FIG. 18 together, the formula relating the initial value of the waiting interval and/or the contention window may be of the form V=MAX(100, 286 log(P)-644), where V is the initial waiting interval and/or the initial contention window, MAX means the larger of the two comma-separated arguments that follow, and log(P) means the base-10 logarithm of the traffic density P, and P equals the probability that a particular node will initiate a new message in a particular time slot, times 10 million, as mentioned. Practitioners may adjust the parameters of this exemplary formula to suit the priorities of their particular LAN, or may devise other formulas determining the initial waiting interval and/or the initial contention window based at least in part on the traffic density.

The delay parameters and other LAN operational parameters may be adjusted using machine learning and/or artificial intelligence. The adjustable parameters may be, for example, the initial waiting interval, the initial contention window, the decrementation amount for each of those, the upper and lower limits for each of those, the numerical parameters in the function relating the values to the traffic density such as that of the previous paragraph, and other dependencies or parameters such as the average delay time for wireless messages, the collision rate, the overall success rate per unit time, and other performance metrics of interest. To implement such a machine learning and/or artificial intelligence means, for adjusting the LAN or protocol parameters, data may be accumulated using simulated or, preferably, real LANs having multiple nodes in competition, and preferably spanning a wide range of conditions such as traffic density. Additional performance data may be acquired by varying the parameters while observing the effects on the performance metrics. Software such as machine learning algorithms may then be used to develop multiparameter correlations between the external conditions such as traffic density and number of nodes, and the adjustable parameters such as delay parameters, to optimize the performance metrics such as throughput. Artificial intelligence may be employed to develop improved means for managing wireless communications to avoid congestion, enable rapid and reliable message transfers, and deterministic responses to changes in conditions. In addition, the machine learning and/or artificial intelligence may be applied to LAN protocols having additional complexity and versatility, such as protocols that support multiple QoS (quality of service) levels, emergency priority services, means for avoiding interference with neighboring LANs, specialized LANs such as fire-fighting or rescue or law-enforcement or military LANs and the like, as well as other wireless communication applications.

The systems and methods disclosed herein can provide numerous advantages not obtainable with prior-art wireless protocols. At medium and high traffic densities, embodiments of the systems and methods can reduce the collision rate substantially, according to some embodiments.

The systems and methods may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, or sooner, are loaded into random access memory. Inputs to the application, e.g., from the plurality of users or from any one user, may be by any number of appropriate computer input devices. For example, users may employ vehicular controls, as well as a keyboard, mouse, touchscreen, joystick, trackpad, other pointing device, or any other such computer input device to input data relevant to the calculations. Data may also be input by way of one or more sensors on the robot, an inserted memory chip, hard drive, flash drives, flash memory, optical media, magnetic media, or any other type of file—storing medium. The outputs may be delivered to a user by way of signals transmitted to robot steering and throttle controls, a video graphics card or integrated graphics chipset coupled to a display that maybe seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., embedded systems and processors, personal computers, laptop computers, notebook computers, net book computers, handheld computers, personal digital assistants, mobile phones, smart phones, tablet computers, and also on devices specifically designed for these purpose. In one implementation, a user of a smart phone or WiFi-connected device downloads a copy of the application to their device from a server using a wireless Internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method.

Embodiments of systems and methods according to present principles can provide high throughput, low message collision rates, and reduced delays in wireless communication. Protocols according to present principles can be beneficially applied to numerous applications, including but not limited to vehicles (e.g., roadway, airborne, waterborne, autonomous, semi-autonomous, human-driven, rental scooters, truck trackers, etc.), personal devices (e.g., mobile phones, health monitors, personal locators, pet locators, etc.), computers (e.g., tablet, laptop, desktop, server, embedded, single-chip, portable, fixed-site, etc.), interconnected devices (e.g., “smart” appliances and controls, entertainment devices, voice-activated assistants, home security systems, etc.), emergency call and response systems (e.g., 911 servers, law enforcement systems, fire response systems, health emergency systems, national defense systems, etc.), responsive monitors and alarms (e.g., intrusion monitors, fire or smoke alarms, weather and other environmental, highway traffic, pedestrian traffic, earthquake monitors, etc.) and innumerable other products that communicate using radio waves. The practicality and usefulness of embodiments according to present principles will become greatly augmented with the widespread adoption of 5G and subsequent wireless generations (such as 6G and following subsequent and future technologies), further driving congestion in the limited bandwidth available.

It is to be understood that the foregoing description is not a definition of the invention but is a description of one or more preferred exemplary embodiments of the invention. The invention is not limited to the particular embodiments(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater, or different steps than that shown here. All such other embodiments, changes, and modifications are intended to come within the scope of the appended claims.

As used in this specification and claims, the terms “for example”, “e.g.”, “for instance”, “such as”, and “like” and the terms “comprising”, “having”, “including”, and their other verb forms, when used in conjunction with a listing of one or more components or other items, are each to be construed as open-ended, meaning that the listing is not to be considered as excluding other additional components or items. Other terms are to be construed using their broadest reasonable meaning unless they are used in a context that requires a different interpretation.

1. A system for wireless communication, comprising:
a transmitter configured to transmit wireless messages;
a receiver configured to receive wireless messages;
a processor operably connected to the transmitter and the receiver; and
non-transient computer-readable media operably connected to the processor, containing instructions for causing the processor to perform a method comprising:
transmitting a first wireless message;
receiving a second wireless message;
transmitting a third wireless message which is at least 10 times longer than the first wireless message;
receiving a fourth wireless message;
transmitting a fifth wireless message which is at least 4 times longer than the third wireless message; and
receiving a sixth wireless message.

2. The system of claim 1, wherein:
the first wireless message is an AQ message requesting permission to send an RTS message;
the second message is a BQ message granting permission to transmit the RTS message;
the third wireless message is the RTS message requesting permission to send a DAT message;
the fourth message is a CTS message bestowing permission to transmit the DAT message;
the fifth wireless message is the DAT message; and
the sixth message is an ACK message.

3. The system of claim 2, wherein the instructions further include instructions for determining that a wireless message was successfully transmitted by receiving a confirmatory reply during a predetermined interval, the confirmatory reply comprising the BQ message or the CTS message or the ACK message, and for determining that the wireless message was not successfully transmitted by failing to receive the confirmatory reply during the predetermined interval.

4. The system of claim 2, further including a base station configured to transmit the BQ message, the CTS message, and the ACK message.

5. The system of claim 4, wherein the base station is further configured to demark time slots, and wherein the AQ message occupies one or two slots.

6. The system of claim 5, wherein the BQ message occupies one or two slots.

7. The system of claim 4, wherein the base station is configured to demark bytes of message data, and wherein the AQ message occupies less than four bytes.

8. The system of claim 7, wherein the processor is configured to inhibit the transmitter from transmitting during bytes other than the bytes occupied by the AQ message, and wherein the processor is configured to detect a transmission from another node during the bytes not occupied by the AQ message.

9. The system of claim 7, wherein the AQ message is positioned randomly within a slot.

10. The system of claim 7, wherein the receiver is configured to detect wireless messages or carrier signals during bytes other than the bytes occupied by the AQ message.

11. The system of claim 4, wherein the base station is configured to detect and interpret bits of message data in a bitwise sequential manner, and wherein the AQ message occupies one or two bits.

12. The system of claim 11, wherein the processor is configured to cause the transmitter to transmit unmodulated carrier signals during times associated with transmission of the bit or bits of the AQ message, and to inhibit the transmitter during bits other than the bits of the AQ message.

13. The system of claim 11, wherein the AQ message is positioned randomly within a slot.

14. The system of claim 11, wherein the processor is configured to detect carrier signals or wireless messages during times when the AQ bits are not being transmitted.

15. A method for wireless communication between a node and a base station of a local area network, comprising:
transmitting, by the node, an AQ message;
transmitting, by the base station, a BQ message responsive to the AQ message;
transmitting, by the node, an RTS message responsive to the BQ message;
transmitting, by the base station, a CTS message responsive to the RTS message;
transmitting, by the node, a DAT message responsive to the CTS message; and
transmitting, by the base station, an ACK message responsive to the DAT message.

16. The method of claim 15, wherein the base station demarks time in sequential time slots of a predetermined length, and the AQ message has a duration of one slot and the BQ message has a duration of one slot.

17. The method of claim 15, wherein the base station demarks time in sequential bytes of a predetermined length, and the AQ message has a duration of two bytes.

18. The method of claim 15, further comprising transmitting, by the base station, a beacon message that includes a local identification code of the base station, wherein the local identification code is persistently associated with the base station and has a length of less than four bytes.

19. The method of claim 18, wherein the AQ message includes the local identification code of the base station.

20. The method of claim 19, wherein the AQ message has the same number of bytes as the local identification code.

21. The method of claim 18, wherein the BQ message includes the local identification code of the base station, and one or more symbols indicating that the BQ message is a BQ message.

22. The method of claim 15, wherein the AQ message has a duration of less than eight bits.

23. The method of claim 22, wherein:
the AQ message comprises one bit of unmodulated carrier signal within a slot;
the slot has no carrier signal therein, other than the one bit comprising the AQ message; and
the base station is configured to transmit a BQ message upon detecting a single bit of unmodulated carrier within a slot having no other carrier signal therein.

24. The method of claim 15, wherein the node is configured to receive a BQ message which is not associated with any AQ message transmitted by the node, and to determine that the BQ message is associated with a different node, and if the BQ message is determined to be associated with a different node, then the node is configured to inhibit transmitting for a predetermined time at least equal to a sum of a duration of the RTS message plus a duration of the CTS message, whereby the BQ message is for the node that sent the AQ message, and all other nodes are configured to remain silent for a time equal to RTS+CTS.

25. A local area network, comprising:
a plurality of nodes, each node comprising a processor, a transmitter, and a receiver; and
a base station comprising a processor, a transmitter, and a receiver; wherein:
each node is configured to initiate wireless communication by transmitting an AQ message to the base station;
the base station is configured to transmit a BQ message responsive to the AQ message;
each node is configured to receive, after transmitting the AQ message, the BQ message, and to transmit an RTS message responsive to the BQ message;
the base station is configured to transmit a CTS message responsive to the RTS message;
each node is configured to receive, after transmitting the RTS message, the CTS message, and to transmit a DAT message responsive to the CTS message;
the base station is configured to transmit an ACK message responsive to the DAT message.

26. The local area network of claim 25, wherein each node is configured to begin a backoff delay upon failing to receive a BQ message within a predetermined interval after transmitting an AQ message, or upon failing to receive a CTS message within a predetermined interval after transmitting an RTS message, or upon failing to receive an ACK message within a predetermined interval after transmitting a DAT message.

27. The local area network of claim 26, wherein the backoff delay comprises a predetermined waiting interval followed by a randomly selected portion of a predetermined contention window.

28. The local area network of claim 27, wherein the AQ message has a duration equal to one slot.

29. The local area network of claim 28, wherein the AQ message comprises two bytes.

30. The local area network of claim 29, wherein the AQ message comprises a single bit of modulated or unmodulated carrier signal.
